(19) United States
(12) Patent Application Publication
(10) Pub. No.: US 2014/0053923 A1
(43) Pub. Date: Feb. 27, 2014

(54) Apparatus and Methods for Limiting or Preventing Backflow of Gas up Through a Plumbing Fixture

(71) Applicant: The Rectorseal Corporation, Houston, TX (US)

(72) Inventors: Robert Allen Martinelli, Katy, TX (US); Zheng-Yi Xu, Houston, TX (US); Tonmoy Roy, Katy, TX (US)

(73) Assignee: The Rectorseal Corporation, Houston, TX (US)

(21) Appl. No.: 13/973,209

(22) Filed: Aug. 22, 2013

Related U.S. Application Data
(60) Provisional application No. 61/743,149, filed on Aug. 27, 2012.
(60) Provisional application No. 61/957,207, filed on Jun. 26, 2013.

(51) Int. Cl. F16K 15/03; E03C 1/298

(52) U.S. Cl. CPC F16K 15/03; E03C 1/298
USPC 137/527.8

(57) ABSTRACT

Apparatus useful for allowing the flow of liquid down through a pluming fixture to a destination below it and limiting or preventing the backflow of gas from the destination up into the pluming fixture includes a frame and a disc pivotably connected thereto. The disc is biased in a closed position and pivotably moveable into an open position upon the application of sufficient forces acting on the upper surface thereof caused by fluid from the plumbing fixture.

### CROSS REFERENCE TO RELATED APPLICATIONS

This application claims priority to U.S. Provisional Patent Application Ser. Nos. 61/743,149 filed on Aug. 27, 2012 and entitled “Waterless Drain Trap Seal Protection Device” and 61/957,207 filed on Jun. 26, 2013 and entitled “Waterless Drain Trap Seal Protection Device”, the entire contents of which are hereby incorporated by reference herein in their entireties.

### FIELD OF THE INVENTION

The present disclosure relates generally to plumbing methods and apparatus, and more particularly, apparatus and methods for limiting or preventing the backflow of gas through plumbing fixtures.

### BACKGROUND OF THE INVENTION

One well-known problem with plumbing fixtures is the backflow of gas from underneath the plumbing fixture. For example, the plumbing fixture may be a floor-mounted drain system that leads to a sewage system. As shown in FIG. 1, a conventional floor-mounted drain system 10 is typically installed in a floor 14 (e.g. concrete, asphalt, wood, dirt, gravel, etc.) to allow the flow of water or other liquids from the floor 14 into the drain system 10. The illustrated system 10 includes a grate 18, a drain basin 22 and a drain conduit 26. When included, the grate 18 is used to catch large items before they enter drain basin 22. The drain conduit 26, when included, typically directs liquids that enter the drain basin 22 down into a sewage system or other destination.

As is well known, foul-smelling and sometimes harmful gasses exist in the piping below the plumbing fixture, sewage system or other destination. It is thus highly desirable to limit or prevent the backflow of such gas up through the plumbing fixture into the room or other structure where it is located. To address this problem, the drain system 10 may include a U-shaped portion (not shown) in the drain conduit 26, sometimes referred to as a P-trap. P-traps have been used in the plumbing industry with various types of fixtures to limit or prevent backflow of the gasses from the underground piping, sewer, etc. into the room, building or other structure, while permitting drainage of water or other liquid. Because of their shape, the lower portion of the P-trap retains a small amount of water (or other liquid) after the fixture's use. The liquid in the trap serves as a barrier or seal to block the backflow of gas up into the drain system 10 and the room, building or other space.

In some circumstances, the P-traps are not always effective at blocking the backflow of gas. For example, if the drain system 10 is located in an area having infrequent or no liquid presence and drainage, the P-trap may not always limit or prevent the backflow of gas. This may occur, for example, when there is no liquid in the P-trap, or liquid in the P-trap evaporates, permitting gas backflow into the drain basin 22 and then up into the room or building through the grate 18. To overcome this consequence, “trap primers” have been used to ensure a minimum level of liquid remains in the U-shaped portion of the P-trap. However, trap primers are often difficult and expensive to install and may require maintenance and frequent monitoring.

Other attempts have been made to slow the evaporation of the water in the P-trap. For example, deformable valves have been proposed to slow the evaporation of the water in the P-trap, such as in U.S. Pat. No. 6,795,987 to Cornwall, U.S. Pat. No. 6,719,004 to Huber, U.S. Pat. No. 803,979 to Bonnell, U.S. Pat. No. 194,329 to Buhrer, U.S. Pat. No. 3,707,986 to Breen, U.S. Pat. No. 4,870,992 to Irwin et al. and US Patent Publication No. 2010/0269913 to Hollinger. A presently commercially available deformable valve sold by Sure Seal has product number NPS-3. Various problems may exist with these types of valves. For example, these valves may be prone to clogging or freeze-up due to the presence or build-up of debris or substances such as grease, wax, dirt, sand, and other organic and inorganic materials.

Yet other types of valves have been proposed to limit or prevent gas backflow, such as collapsible membrane or diaphragm-type, one-way check valves. Some examples of these valves are disclosed in U.S. Pat. Nos. 6,273,124 and 6,318,397 to Huber. These solutions are typically complicated, expensive, may require maintenance and tight tolerances to work effectively, and may be prone to clogging or freeze-up due to the presence or build-up of debris or substances (e.g. grease, wax, dirt, sand and other organic and inorganic materials).

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the cited examples, features and/or disadvantages, merely because of the mention thereof herein.

Accordingly, there exists a need for improved systems, apparatus and methods for limiting or preventing the back-flow of gas up through a plumbing fixture having one or more of the attributes or capabilities mentioned below or as may be evident from the description or appended drawings herein: effectively limits or prevents at least substantial gas backflow when there is no P-trap or no liquid in the P-trap; is effective in a floor drain system or other plumbing fixture that is seldom used; requires low maintenance; is inexpensive to manufacture; is not prone to clogging; involves a valve that is simple and has few parts, easily installed, rigid, durable, long-lasting, biased closed and openable by the force of liquid from the drain system, or a combination thereof.

### BRIEF SUMMARY OF THE DISCLOSURE

In some embodiments, the present disclosure involves a valve useful for allowing the flow of liquid down through a floor-mounted drain basin to a destination below it and limiting or preventing the backflow of gas. The valve includes a circular-shaped frame and a disc. The frame is configured to be positioned between the drain basin and destination, and includes a central passageway and an interior surface extending around the central passageway. The central passageway is in fluid communication with the drain basin and destination. The interior surface has first and second sides. The first side includes a downwardly facing ledge and the second side includes an upwardly facing ledge.

The disc has a central axis and is pivotably connected to the frame between the first and second sides of the interior surface thereof. The disc is pivotably movable between a closed position and at least one open position within the central passageway about its central axis. The disc has a first section configured to engage the downwardly facing ledge of the interior surface of the frame and a second section configured to simultaneously engage the upwardly facing ledge. The disc is configured so that the engagement of the first section with the downwardly facing ledge and the second section with the upwardly facing ledge stops the pivoting movement of the disc in one direction and defines the closed position of the disc relative to the frame. The closed position of the disc limits or prevents fluid communication between the drain basin and the destination through the central passageway. When the first and second sections are simultaneously disengaged from the respective downwardly and upwardly facing ledges, the disc is in an open position and allows fluid communication between the drain basin and the destination through the central passageway.

In various embodiments, the present disclosure involves a valve useful for allowing the flow of liquid down through a pluming fixture to a destination below it and limiting or preventing the backflow of gas from the destination up into the pluming fixture. The valve includes a circular-shaped frame and a rigid disc. The frame is configured to be positioned between the plumbing fixture and destination, and includes a central passageway in fluid communication with the plumbing fixture and the destination. The disc includes upper and lower surfaces and is pivotably connected to the frame within the central passageway.

The disc is pivotably movable between a closed position and at least one open position. The closed position limits or prevents, and the open position allows, fluid communication between the plumbing fixture and the destination through the central passageway. The disc is biased in the closed position sufficient to prevent the forces of backflow gas from the destination acting upon the lower surface of the rigid disc from moving the rigid disc into an open position. The disc is automatically moveable from the closed position into the open position upon the application of sufficient forces on the upper surface thereof caused by fluid in the central passageway, and thereafter automatically moveable from the open position to the closed position upon the absence of sufficient fluid in the central passageway to overcome the biasing forces acting upon the disc.

Accordingly, the present disclosure includes features and advantages which are believed to enable it to advance plumbing technology. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 is a cross-sectional view of an example prior art floor-mounted drain system;

FIG. 2 is a cross-sectional view of an embodiment of a gas backflow prevention valve shown used in connection with an exemplary floor-mounted drain system in accordance with the present disclosure;

FIG. 3A is a perspective view of the exemplary gas backflow prevention valve of FIG. 2 shown having its disc in a closed position;

FIG. 3B is a perspective view of the exemplary gas backflow prevention valve of FIG. 2 shown having its disc in an open position;

FIG. 4 is cross-sectional view of another embodiment of a gas backflow prevention valve in accordance with the present disclosure shown having its disc in an open position;

FIG. 5 is cross-sectional view of the gas backflow prevention valve of FIG. 4 shown having its disc in a closed position; and

FIG. 6 is cross-sectional view of yet another embodiment of a gas backflow prevention valve in accordance with the present disclosure shown having its disc in a closed position.

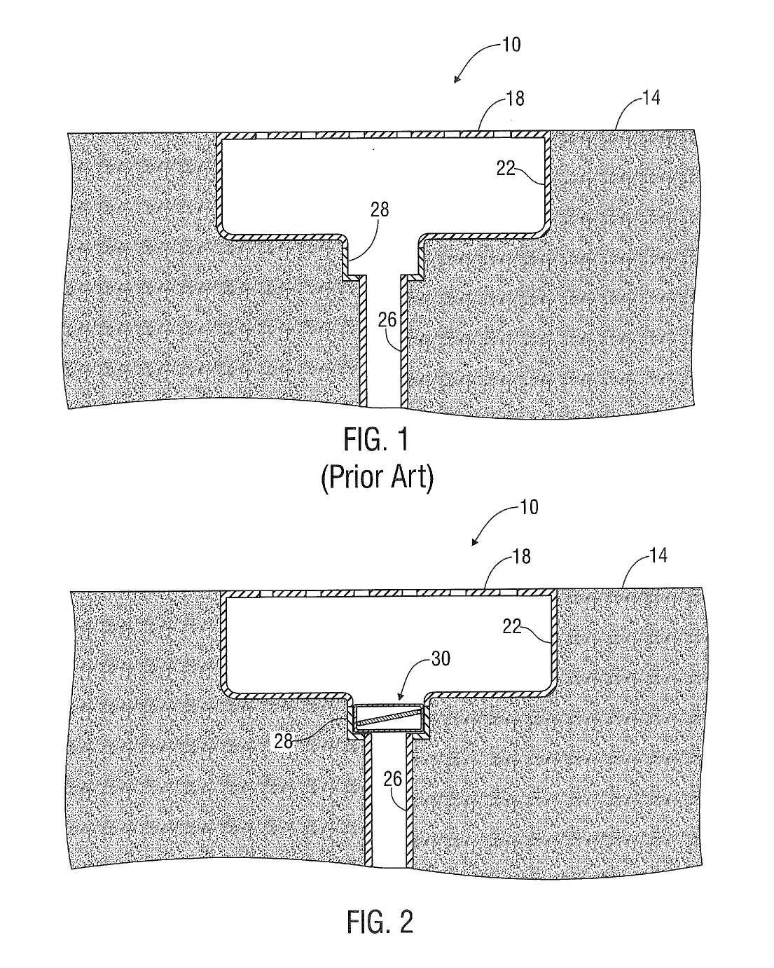

### DETAILED DESCRIPTION OF PREFERRED EMBODIMENTS

Characteristics and advantages of the present disclosure and additional features and benefits will be readily apparent to those skilled in the art upon consideration of the following detailed description of exemplary embodiments and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

In showing and describing preferred embodiments, common or similar elements are referenced with like or identical reference numerals or are apparent from the appended figures and/or the description herein. When multiple figures refer to a component or feature with the same reference numeral, any description herein of the component or feature with respect to any of the figures applies equally to the other figures to the extent such description does not conflict with a description herein of the other figure(s). The figures are not necessarily to scale and certain features and certain views of the figures may be shown exaggerated in scale or in schematic in the interest of clarity and conciseness.

As used herein and throughout various portions (and headings) of this patent, the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference. The terms “coupled”, “connected”, “engaged” and the like, and variations thereof, as used herein and in the appended claims are intended to mean either an indirect or direct connection or engagement. Thus, if a first device couples to a second device, that connection may be through a direct connection, or through an indirect connection via other devices and connections.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

Referring to FIG. 2, in accordance with an embodiment of the present disclosure, a gas backflow prevention valve 30 is shown associated with a floor-mounted drain system 10 that fluidly communicates with a liquid destination (not shown), such as a sewage system, piping, etc. The valve 30 is useful to assist in limiting or preventing the backflow of gases from the destination through the drain system 10 even when there is little or no liquid entry into the drain system 10. As used herein, the terms “limit” and variations thereof in regards to limiting gas backflow means allowing an amount of gas backflow that is minimal and within regulatory standards and/or acceptable limits. It should be noted, the valve 30 may be used in connection with any other types of plumbing applications (e.g. sinks, bathtubs, showers, etc.) similarly as described and shown herein. Thus, although the valve 30 is shown and described herein in the context of a floor-mounted drain system 10, the present disclosure is not limited to use with floor-mounted drain systems. The valve 30 may have any suitable form, configuration, components and operation as long, as it can be used to limit or prevent the backflow of gasses up through the drain system 10.

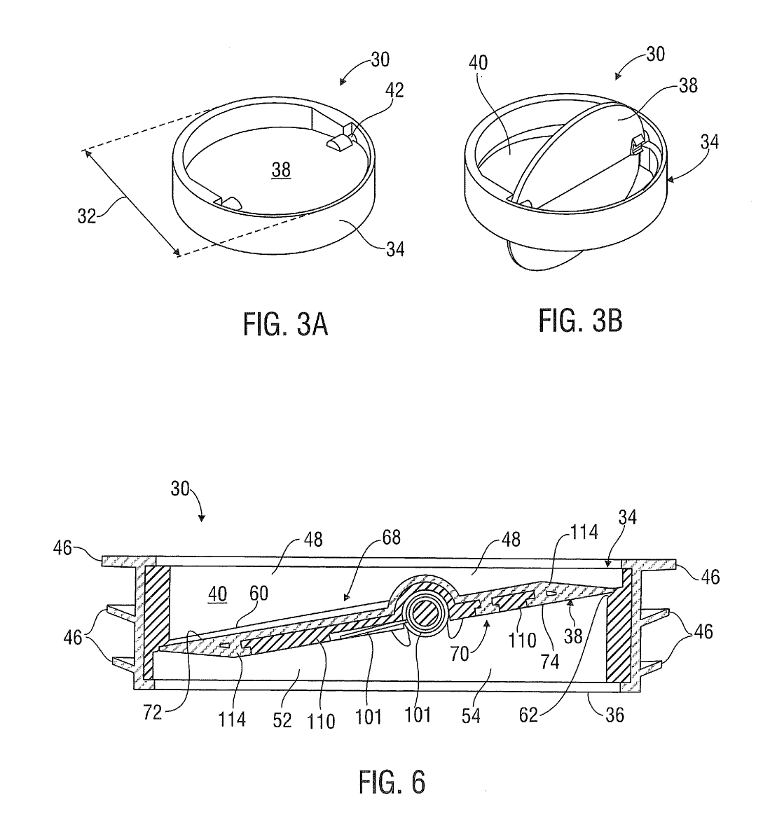

As shown in FIGS. 3A and 3B, the exemplary valve 30 includes a frame 34 and a disc 38 pivotably connected thereto. The frame 34 and disc 38 may have any suitable form, configuration and operation, and may be constructed of any suitable materials or combination of materials. For example, the frame 34 and disc 38 may be constructed of one or more metals, plastics, ceramics, wood, or a combination thereof, and may be manufactured by any suitable process, such as injection molding and machining In the present embodiment, the frame 34 and disc 38 are rigid constructed of rigid thermoplastic material, such as PVC, PP, PS, PC, PET or PMMA, by injection molding. The frame 34 and disc 38 may also have any suitable size. For example, the frame 34 may have an outer diameter 32 (FIG. 3A) of 2 inches, 3 inches, 4 inches and so on.

Referring back to FIG. 2, the valve 30 may be coupled to or positioned in any desired components(s) of the floor-mounted drain system 10, or other components, as long as it is located somewhere between, and in fluid communication with, the system 10 and liquid destination (not shown). In this embodiment, the valve 30 may be mounted or inserted directly into the drain conduit 26, or in a coupling 28 used to connect the drain basin 22 and the drain conduit 26. As used herein and in the appended claims, the term “between” when referring to the location of the valve 30 relative to a plumbing fixture (e.g. floor-mounted drain system 10) and destination, means connected to or placed in any component so long as fluid flowing between the central passageway (e.g. passageway 40) of the fixture and the destination must flow through the valve 30.

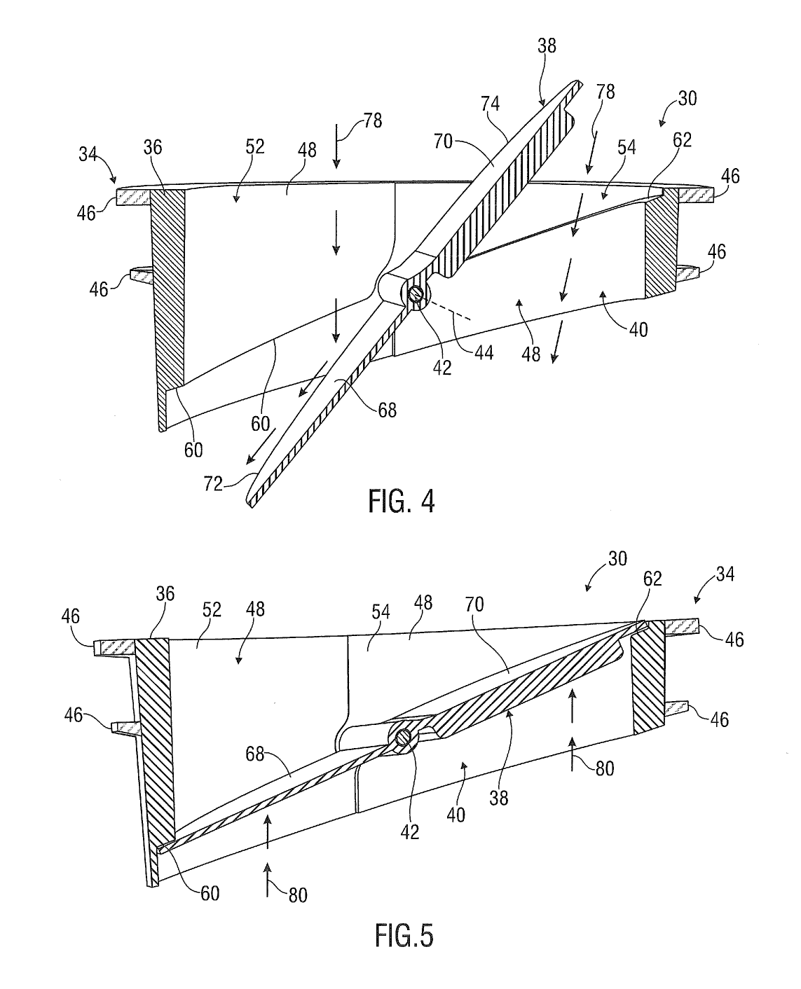

The exemplary valve 30 preferably fits snugly within, or sealingly engages, the drain conduit 26 and/or coupling 28 sufficient to at least substantially prevent fluid from passing around the perimeter of the valve 30. Any suitable mechanism may be used to form this snug fit, or sealing engagement. For example, one or more rubber or elastomeric O-ring seals or gaskets (not shown) may be provided around the perimeter of the valve 30. For another example, one or more sealing fingers 46 (e.g. FIGS. 4-6) may extend outwardly from the perimeter of the frame 34 into engagement with the drain conduit 26, coupling 28 or other component. The sealing fingers 46 may have any suitable form, configuration and operation as long as they assist in forming a snug fit, or fluid-tight seal around the valve 30. If desired, the sealing fingers 46 may be compressible elastomeric protrusions sized and shaped to slip into, and then sealing engage, the drain conduit 26 or coupling 28. In this example, each sealing finger 46 is a compressible rubber lip that extends around the periphery of the frame 34. When included, the sealing fingers 46 may be integral to the frame 34, coupled thereto or sealingly engaged therewith.

Referring back to FIGS. 3A and 3B, the exemplary frame 34 is circular and includes a central passageway 40 within which the disc 38 is seated. The central passageway 40 is in fluid communication with the drain basin 22 (above the valve 30) and one or more liquid destination, such as a sewage system, below the valve 30. The illustrated disk 38 pivots between a closed position (FIG. 3A) and at least one open position (FIG. 3B). The disc 38 may be pivotably connected to the frame 34 in any suitable manner. For example, first and second opposing pivot pins 42 extending from the disc 38 may engage and be rotatable in corresponding first and second seats (not shown) in the frame 34. As used herein, the term “pin” includes a pin, rod, protrusion, bar, nipple or any other suitable structure that enables the disc 38 to pivot relative to the frame 34. In other embodiments, one or both pins 42 could instead be provided on the frame 34 and the corresponding seat(s) provided on the disc 38. In yet other embodiments, a single pivot pin 42 (e.g. FIG. 4) may extend through the disc 38 and engage the frame 34 at its opposing ends. Likewise, any other suitable mechanism may be used to allow the disc 38 to pivot relative to the frame 34. Thus, the present disclosure is not limited by the mechanism that enables pivoting of the disc 38 relative to the frame 34.

Now referring to the embodiment of FIG. 4, the illustrated frame 34 is a cylindrically-shaped collar 36 having an interior surface 48 that defines and the central passageway 40. The interior surface 48 of the exemplary collar 36 includes at least first second sides 52, 54. The first side 52 includes a downwardly facing ledge 60, and the second side 54 includes an upwardly facing ledge 62. In this example, the ledges 60, 62 stop movement of the disk 38 in the clockwise direction. However, the exemplary valve 30 may be arranged with the opposite configuration. If desired, the ledges 60, 62 may be aligned in a sloping or angled disposition across their respective sides 52, 54 of the interior surface 48. For example, in this embodiment, the ledges 60, 62 are aligned along an upwardly angled plane with the downwardly facing ledge 60 at the lower end of the plane and the upwardly facing ledge 62 at the upper end of the plane.

Still referring to the example of FIG. 4, the disc 38 is rotatable about its central axis 44 and includes first and second sections 68, 70. The perimeter edge 72 of the first section 68 is sized and shaped to abut and sealingly engage the downward facing ledge 60, while the perimeter edge 74 of the second section 70 is sized and shaped to abut and sealingly engage the upwardly facing ledge 62. “Sealing engagement” and variations thereof as used herein and in the appended claims means to form an at least substantially gas-tight seal. When the first and second sections 68, 70 sealingly engage the respective associated ledges 60, 62, this represents the “closed” position of the disc 38 (and valve 30), at least substantially disallowing the backflow of gas from below the valve 30 up into the drain basin 22. In this embodiment, the first section 68 of the disc 38 is thus movable only downwardly from the closed position, while the second section 70 is movable only upwardly from the closed position. In some embodiments, the perimeter edges 72, 74 are flexible so that they conform to the shape of the upwardly and downwardly facing ledges 60, 62, respectively. Positioning of the disc 38 in any position other than its closed position represents an “open” position of the disc 38 and valve 30, allowing fluid communication between the drain basin 22 and whatever is located below the valve 30 (e.g. the drain conduit 26 and liquid destination). However, the present disclosure is not limited to the above configuration. For example, there may be only a single ledge on the interior surface 48 of the frame 34 that is sealingly engaged by the disc 38. Likewise, any other mechanism may be used to stop movement of the disc 38 in the closed position.

Now referring to the embodiment of FIG. 5, if desired, the valve 30 may be configured so that the disc 38 is biased into the closed position. In this embodiment, the disc 38 would thus be biased in a clockwise direction. Any suitable mechanism may be used to bias the disc 38 in the closed position. For example, the second section 70 may be heavier than first section 68. This may be accomplished in any suitable manner, such as by forming the second section 70 with more volume of material (e.g. thickness) and/or more dense material (e.g. lead ballast) than the first section 68, forming the first section 68 with lighter material, affixing weights to the second section 70, or any desired combination thereof. In this embodiment, the second section 70 is thicker and heavier than the first section 68. When the second section 70 is sufficiently heavier than the first section 68, the valve 30 may be designed so that gravity forces acting on the disc 38 will sufficiently bias the second section 70 of the disc 38 into sealing engagement with the upwardly facing ledge 62, and the first section 68 of the disc 38 into sealing engagement with the downwardly facing ledge 60 (FIG. 5). Other example mechanisms for biasing the disc 38 in the closed position include the use of one or more magnets, biasing members (e.g. springs), or any other suitable component(s) acting on the first and/or second sections 68, 70 of the disc 38. For example, as will be described further below, the disc 38 of FIG. 6 is spring-biased into a closed position by at least one spring 101.

Still referring to FIG. 5, in this embodiment, the valve 30 may be configured so that the disc 38 remains in the closed position when there is little or no liquid entering the valve 30 from above. For example, the second section 70 of the exemplary disc 38 can be sized to be unseatable by gas backflow forces (arrows 80) acting on the bottom surface, or underside, of the disc 38. In this instance, typical, or expected, upward pressure acting on the disc 38 from below the valve 30 would be insufficient to overcome the closing biasing forces on the disc 38. Accordingly, gas is blocked from passing up through the exemplary valve 30 into the drain basin 22.

Referring back to FIG. 4, the illustrated disc 38 is moveable to an open position upon sufficient downward forces acting upon the upper surface of its first section 68 to overcome the closing biasing forces. For example, the exemplary disc 38 moves into an open position when a sufficient quantity of liquid (arrows 78) from the drain basin 22 enters the valve 30 to bias the first section 68 of the disc 38 in a downward or counterclockwise direction. Liquid, such as water, entering the valve 30 will move the exemplary disc 38 into an open position and allow liquid to drain into the drain conduit 26 or the liquid destination below the valve 30. It should be noted that gas pressure, or any other suitable force, acting upon the disc 38 from above may likewise bias the disc 38 into an open position.

If desired, the valve 30 may be configured so that liquid entering the valve 30 from above is encouraged to flow toward the first section 68 of the disc 38 and assist in opening the disk 38. This may be accomplished, for example, by positioning the second section 70 higher than the first section 68 in the central passageway 40 of the frame 34 when the disc 38 is closed. In the present embodiment, in the closed position, the first section 68 is situated angled downwardly from the second section 70 due to the angled orientation of the ledges 60, 62 on the respective sides 52, 54 of the interior surface 48 of the frame 34, as previously described. Accordingly, liquid entering the exemplary valve 30 from above will flow downhill toward first section 68 of disc 38 and accumulate there until its weight overcomes the closing biasing forces acting on the disc 38. At that stage, the disc 38 will automatically pivot (e.g. counterclockwise) into an open position, allowing the liquid to freely flow down past the valve 30 and into the drain conduit 26 (or other components below the valve 30). Thereafter, when sufficient liquid ceases to flow into the valve 30 from above, the biasing forces acting on the disc 38 will automatically pivot the disc 38 back in the opposite (e.g. clockwise) direction to the closed position. In this embodiment, the weight of the second section 70 of the disc 38 will cause the disc 38 to close. The above opening and closing sequence should automatically continue on an on-going basis.

Now referring to FIG. 6, the disc 38 of this embodiment includes a rigid inner core 110 that is at least partially covered with a flexible cover 114. The rigid core 110 may be desirable, for example, to provide strength and rigidity of the disc 38, which could improve its performance, reliability, longevity, durability or a combination thereof. For example, in some circumstances, the rigid core 110 may assist in preventing clogging or freeze-up of the valve 30 by overcoming the effect of debris or other substances in or near the valve 30. The flexible cover 114 may be included to help improve the sealing engagement of the perimeter edges 72, 74 of the respective first and second sections 68, 70 of the disc 38 with the upwardly and downwardly facing ledges 60, 62. Further, the malleability of flexible cover 114 may allow at least some portions of the edges 72, 74 to engage at least some parts of the upwardly and downwardly facing ledges 60, 62 when one or more foreign object, debris or other substances are present. In such instance, the flexible cover 114 may allow the valve 30 to at least limit the backflow of gas into the drain basin 22 from below. In a preferred embodiment, the flexible cover 114 or, alternately, any other form of a flexible perimeter around the disc 38, is malleable enough to limit or prevent gas backflow even if a rod or rod-like structure having a diameter of as much as 1/8″ is lodged between the disc 38 and the ledge 60 and/or 62.

The flexible cover 114 and rigid core 110 may have any suitable form, configuration and operation and be constructed of any suitable material or combination of materials. For example, the illustrated rigid core 110 is constructed of hard plastic, such as polypropylene or polystyrene, and the illustrated flexible cover 114 is constructed of silicon rubber or other rubber-like substance. The flexible cover 114 and rigid core 110 may be assembled in any suitable manner, such as by an over-molding process. While the flexible cover 114 is only necessary on the perimeter edges 72, 74 of the first and second respective sections 68, 70 of the disc 38, it may extend on or around additional portions of the rigid core 110. This may be desirable, for example, to simplify the over-molding process and/or to make disc 38 as durable as possible. In other embodiments, the disc 38 may be constructed entirely of flexible material, such as to encourage sealing engagement of the first and second sections 68, 70 of the disc with the respective downwardly and upwardly facing ledges 60, 62.

Still referring to FIG. 6, in this embodiment, the closing biasing forces on the disc 38 are provided by at least one spring 101, as mentioned above. The illustrated spring 101 engages, or connects to, the rigid core 110 and biases the first section 68 of the disc 38 upwardly into engagement with the downwardly facing ledge 60. However, any other orientation of one or more spring 101 may be used.

Preferred embodiments of the present disclosure thus offer advantages over the prior art and are well adapted to carry out one or more of the objects of this disclosure. However, the present invention does not require each of the components and acts described above and is in no way limited to the above-described embodiments, variables, values, value ranges or methods of operation. Any one or more of the above components, features and processes may be employed in any suitable configuration without inclusion of other such components, features and processes. Moreover, the present invention includes additional features, capabilities, functions, methods, uses and applications that have not been specifically addressed herein but are, or will become, apparent from the description herein, the appended drawings and claims. Further, all of the value and value ranges provided herein and in the appended claims are intended to be approximate, as that term is defined herein.

The methods that may be described above or claimed herein and any other methods which may fall within the scope of the appended claims can be performed in any desired suitable order and are not necessarily limited to any sequence described herein or as may be listed in the appended claims. Further, the methods of the present invention do not necessarily require use of the particular embodiments shown and described herein, but are equally applicable with any other suitable structure, form and configuration of components.

While exemplary embodiments of the invention have been shown and described, many variations, modifications and/or changes of the system, apparatus and methods of the present invention, such as in the components, details of construction and operation, values, arrangement of parts and/or methods of use, are possible, contemplated by the patent applicant(s), within the scope of the appended claims, and may be made and used by one of ordinary skill in the art without departing from the spirit or teachings of the invention and scope of appended claims. Thus, all matter herein set forth or shown in the accompanying drawings should be interpreted as illustrative, and the scope of the disclosure and the appended claims should not be limited to the embodiments described and shown herein.

1. A valve useful for allowing the flow of liquid down through a floor-mounted drain basin to a destination below it and limiting or preventing the backflow of gas from the destination up into the floor-mounted drain basin, the valve comprising:
a circular-shaped frame configured to be positionable between the drain basin and the destination, said frame including a central passageway and an interior surface extending around said central passageway, said central passageway being in fluid communication with the drain basin and the destination, said interior surface having first and second sides, said first side including a downwardly facing ledge and said second side including an upwardly facing ledge; and
a disc having a central axis, being pivotably connected to said frame between said first and second sides of said interior surface thereof, wherein said disc is pivotably movable between a closed position and at least one open position within said central passageway about said central axis,
said disc having a first section configured to engage said downwardly facing ledge of said interior surface of said frame and a second section configured to simultaneously engage said upwardly facing ledge,
wherein said disc is configured so that the engagement of said first section with said downwardly facing ledge and said second section with said upwardly facing ledge stops the pivoting movement of said disc in one direction and represents the closed position of said disc relative to said frame, wherein said closed position of said disc at least limits fluid communication between the drain basin and the destination through said central passageway,
further wherein said first and second sections are simultaneously disengageable from said respective downwardly and upwardly facing ledges, the disengagement of said first and second sections from said respective downwardly and upwardly facing ledges representing an open position of said disc, said open position allowing fluid communication between the drain basin and the destination through said central passageway.

2. The valve of claim 1 wherein when said disc is in said closed position, said first section of said disc is configured to sealingly engage said downwardly facing ledge of said interior surface of said frame and said second section of said disc is configured to sealingly engage said upwardly facing ledge, whereby said central passageway of said frame is completely blocked when said disc is in said closed position, disallowing the backflow of gas from the destination up through said central passageway into the drain basin.

3. The valve of claim 1 wherein said disc is configured to be biased in said closed position sufficient to limit movement of said disc into an open position by the forces of backflow gas acting upon said disc from below.

4. The valve of claim 3 wherein said disc is configured to be pivotably movable from said closed position to said open position upon the presence of sufficient liquid in said central passageway of said frame above said disc.

5. The valve of claim 4 wherein said second section of said disc is heavier than said first section of said disc, whereby the weight of said second section biases said disc in said closed position.

6. The valve of claim 5 wherein said disc is configured to be movable from said closed position to said open position upon the application of sufficient forces acting upon said first section of said disc from above.

7. The valve of claim 6 wherein said disc is configured so that a sufficient volume of liquid entering said central passageway from the drain basin and acting on said first section of said disc exceeds the weight of said second section of said disc, causing said disc to pivotably move into said open position and allow the flow of liquid from the drain basin to the destination.

8. The valve of claim 7 wherein said disc is configured to automatically move from said open position to said closed position upon the absence of liquid acting upon said first section of said disc from above, wherein the weight of said second section causes said disc to pivotably move into said closed position.

9. The valve of claim 5 wherein said second section of said disc is substantially thicker than said first section of said disc.

10. The valve of claim 5 wherein said second section of said disc includes denser material than the said first section of said disc.

11. The valve of claim 4 further including at least one spring acting upon said disc, wherein said disc is spring-biased into said closed position.

12. The valve of claim 11 wherein said disc is configured so that a sufficient volume of liquid entering said central passageway from the drain basin and acting on said first section of said disc exceeds the biasing forces of said at least one spring acting upon said disc, causing said disc to pivotably move into said open position and allow the flow of liquid from the drain basin to the destination.

13. The valve of claim 12 wherein said disc is configured to automatically move from said open position to said closed position when there is insufficient liquid force acting upon said first section of said disc from above to overcome the biasing forces of said at least one spring acting upon said disc, wherein said at least one spring biases said disc into said closed position.

14. The valve of claim 3 wherein said disc is rigid.

15. The valve of claim 3 wherein said first section of said disc is positioned in said central passageway downstream of said second section of said disc when said disc is in said closed position.

16. The valve of claim 15 wherein liquid entering said central passageway flows towards said first section of said disc when said disc is in a closed position.

17. The valve of claim 15 wherein said upwardly and downwardly facing ledges are aligned with one another along an upwardly angled plane across said interior surface of said frame, wherein said upwardly facing ledge is disposed at the upper end of the upwardly angled plane.

18. The valve of claim 17 wherein liquid entering said central passageway flows to said first section of said disc when said disc is in a closed position.

19. The valve of claim 3 wherein said disc has a flexible perimeter configured to conform to the shape of at least one among said upwardly and downwardly facing ledges.

20. The valve of claim 19 wherein said disc includes a rigid inner core and a flexible cover at least partially covering said rigid inner core.

21. A valve useful for allowing the flow of liquid down through a pluming fixture to a destination below it and limiting or preventing the backflow of gas from the destination up into the pluming fixture, the valve comprising:
a circular-shaped frame configured to be positionable between the plumbing fixture and the destination, said frame including a central passageway in fluid communication with the plumbing fixture and the destination; and
a rigid disc having upper and lower surfaces, said rigid disc being pivotably connected to said frame within said central passageway and pivotably movable between a closed position and at least one open position, said closed position of said rigid disc at least limiting, and said open position of said rigid disc allowing, fluid communication between the plumbing fixture and the destination through said central passageway,
said rigid disc being biased in said closed position sufficient to prevent the forces of backflow gas from the destination acting upon said lower surface of said rigid disc from moving said rigid disc into an open position, said rigid disc being automatically moveable from said closed position into said open position upon the application of sufficient forces on said upper surface thereof caused by fluid in said central passageway, and said rigid disc being automatically moveable thereafter from said open position to said closed position upon the absence of sufficient fluid in said central passageway to overcome the biasing forces acting upon said rigid disc.

22. The valve of claim 21 wherein said rigid disc includes a rigid inner core and a flexible perimeter.

23. The valve of claim 21 further including at least one spring acting upon said rigid disc, wherein said disc is spring-biased into said closed position.

24. The valve of claim 21 wherein said rigid disc has at least first and second sections, wherein said second section of said rigid disc is heavier than said first section of said rigid disc, whereby the weight of said second section biases said rigid disc in said closed position.
